(19) United States
(12) Patent Application Publication
(10) Pub. No.: US 2011/0185874 A1
(43) Pub. Date: Aug. 4, 2011

(54) Punch Press

(76) Inventor: Jason Blair, Gonzales, LA (US)

(21) Appl. No.: 12/696,407

(22) Filed: Jan. 29, 2010

(51) Int. Cl. B26F 1/14

(52) U.S. Cl. 83/685

(57) ABSTRACT

An improved and efficient punch press comprising a unique assembly of adjustable and interchangeable components to offer a device that is versatile in its applications.

### BACKGROUND OF THE INVENTION

1. Field of the Invention

This invention relates to punch presses in general, and more particularly, to an improved and versatile punch press comprising a unique assembly of movable, adjustable, and interchangeable parts.

2. Prior Art

Punch presses are well known in the prior art for forming and cutting metal work pieces. A variety of punch presses exist in the prior art. Punch presses may be manually controlled, numerically controlled through a computer (CNC), or hydraulically and/or electrically operated. Punch presses in general comprise a die set. A die set in turn includes a male punch and a female die. At the beginning of the punching process, the male punch is temporality affixed to the end of a ram configured to move in a vertically linear manner. The female die is situated in a table or work bed. A work piece is positioned between the male punch and the female die. To initiate the punching sequence, the ram is moved downward, causing the male punch to enter the work piece and push it through the female die. This creates a desired hole or deformity in the work piece at a pre-determined and specified site, usually at the center of the work piece. The terms “bottom dead center” (BDC) and “top dead center” (TDC) are commonly utilized to designate the top and bottom of a stroke of the ram.

Struts or strut channels are common types of work pieces utilized with punch presses. They are generally comprised of steel or aluminum. Struts are structural systems used in both the electrical and construction industries, and are commonly utilized to support wiring, plumbing or mechanical components. In construction, the strut is formed from a metal sheet. The sheet is folded over to form an open box-like channel with inward curving lips. These lips in turn provide stiffness and an area on which to mount other interconnecting elements. Several variations are available regarding the size and thickness of struts. The dimensions of a single-strut, in the open box section, is typically 1⅝ by 1⅝ inch square cross section. A single-shallow-strut is also available, having half the height of the single strut, and being 1⅝ inch wide, 13/16 inch tall. A single-deep-strut being 2 7/16 to 3¼ inches tall and 1⅝ inch wide is also manufactured. In additional, two single-struts can also be welded together back to back to form a double-strut. Furthermore, two or more single-shallow-struts can also be welded together back to back to form a double-shallow-strut.

Single-struts and single-shallow struts are generally provided with pre-drilled center holes in their bases, through the use of punch presses, via the method described above. These center holes facilitate interconnection of the struts to other struts, as well as allowing for the strut to be connected to an underlying building structure.

In addition to center holes, it is often desirable for single-struts and double-struts to comprise side holes, to provide flexibility in how the strut is utilized and to further enhance interconnection of the strut to other struts, or to a building structure. Although a typical prior art punch press is able to create center holes in single-struts and single-shallow-struts, the inventor is not aware of a prior art punch press that is configured to create side holes in single-struts or double-struts. Furthermore, the inventor is not aware of a prior art punch press that is configured to create center holes in a single-deep strut, a double-strut, or a double-shallow strut. This is because a typical prior art punch press comprises a rigid assembly of non-flexible components. And although the male punch and female die are removable components, their positioning on the punch press is pre-set, and not adjustable. Furthermore, the male punch and female die of many prior art punch presses are not interchangeable with other die sets. As a result, a typical prior art punch press does not confer flexibility in what type of applications it can be used in. As discussed above, a typical prior art punch press is only configured to accept single-struts and single-shallow struts as work pieces, and even then, it is only capable of creating center holes in these type of struts.

As a result of the above-discussed shortcomings of prior art press punches, their use is of a limited benefit to companies in the construction and electrical industries. Thus, if such companies desire to create side holes in any of the variety of struts discussed above, or if they desire to create center holes in any other type of strut beside the single-strut and single-shallow strut, then a typical prior art punch press will not be suitable for such purposes. In such scenarios, these companies are then forced to expend a vast amount of money, labor, and time to mechanically or automatically drill holes on site.

Therefore, an improved punch press meeting the following objectives would be highly desirable in the industry.

### OBJECTS OF THE INVENTION

It is an object of the invention to provide an improved punch press that reduces the disadvantages of prior art punch presses.

It is an object of the invention to provide an improved and efficient punch press that reduces the financial, labor, and time concerns associated with prior art punch presses.

It is another object of the invention to provide an improved punch press that is capable of accepting a variety of struts as work pieces.

It is another object of the invention to provide an improved punch press that is capable of forming both center and side holes in different types of struts.

It is another object of the invention to provide an improved punch press that is versatile in its applications.

Other objects and advantages of this invention shall become apparent from the ensuing description of the invention.

### SUMMARY OF THE INVENTION

An improved punch press is disclosed. The punch press is configured to form center and side holes in a variety of strut applications. The punch press comprises a plurality of female dies comprising channels that allow for side or center orientation of the strut and a plurality of male punches compatible with the female dies.

### BRIEF DESCRIPTIONS OF THE DRAWINGS

The accompanying drawings illustrate a preferred embodiment of this invention. However, it is to be understood that these embodiments are not intended to be exhaustive, nor limiting of the invention. They are but examples of some of the forms in which the invention may be practiced.

FIGS. 1-3 depict examples of prior art punch presses. FIG. 2 depicts a punch press capable of receiving only an angle iron channel as a work piece, as opposed to a strut. FIG. 3 depicts a punch press capable of only creating center holes in single-struts and single-shallow struts.

FIGS. 4, 5, 6, and 7 depict the use of a preferred embodiment of the punch press of the present invention in a single-strut and double-strut application, respectively, for center hole punching.

FIGS. 8, 9 and 10 depict the use of a preferred embodiment of the punch press in a single-strut and double-strut application, respectively, for side hole punching.

FIGS. 11 and 12 depict the use of a preferred embodiment of the punch press in a double-shallow-strut application, for center hole punching.

FIG. 13 depicts preferred center and side hole strut applications of the present invention.

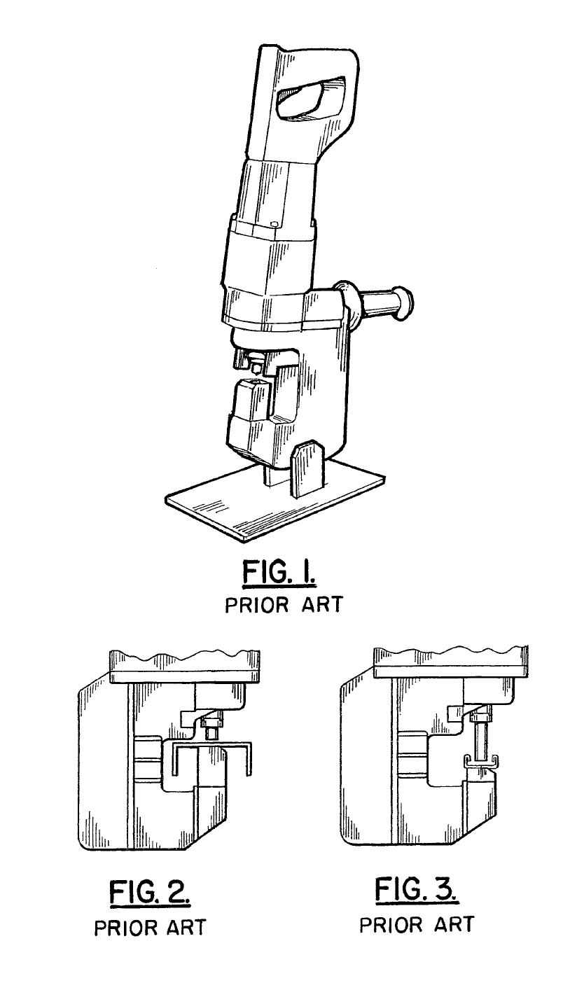

### DESCRIPTION OF THE PREFERRED EMBODIMENTS OF THIS INVENTION

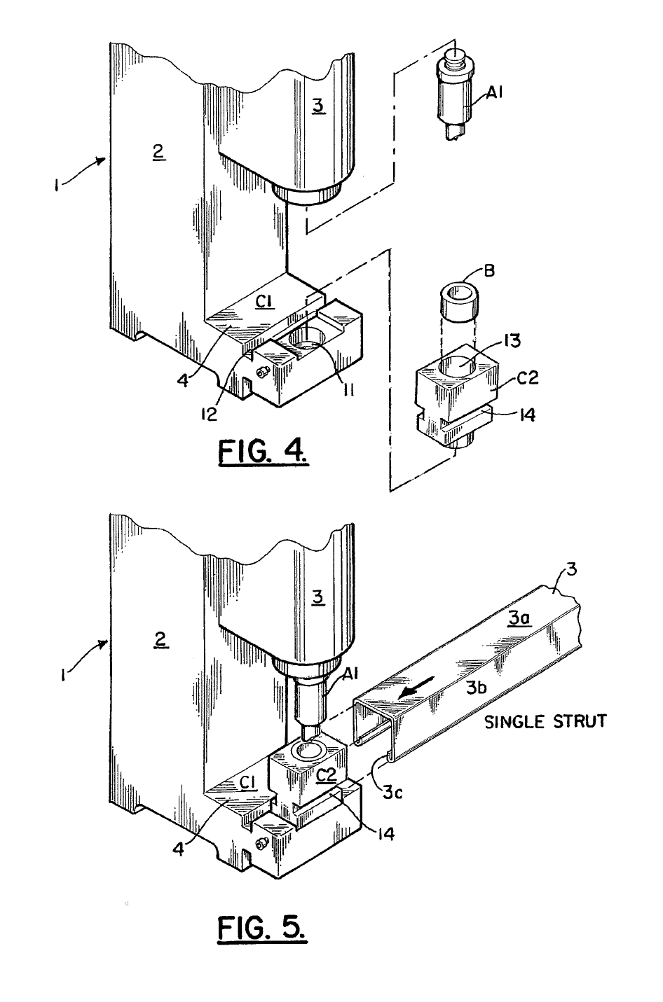

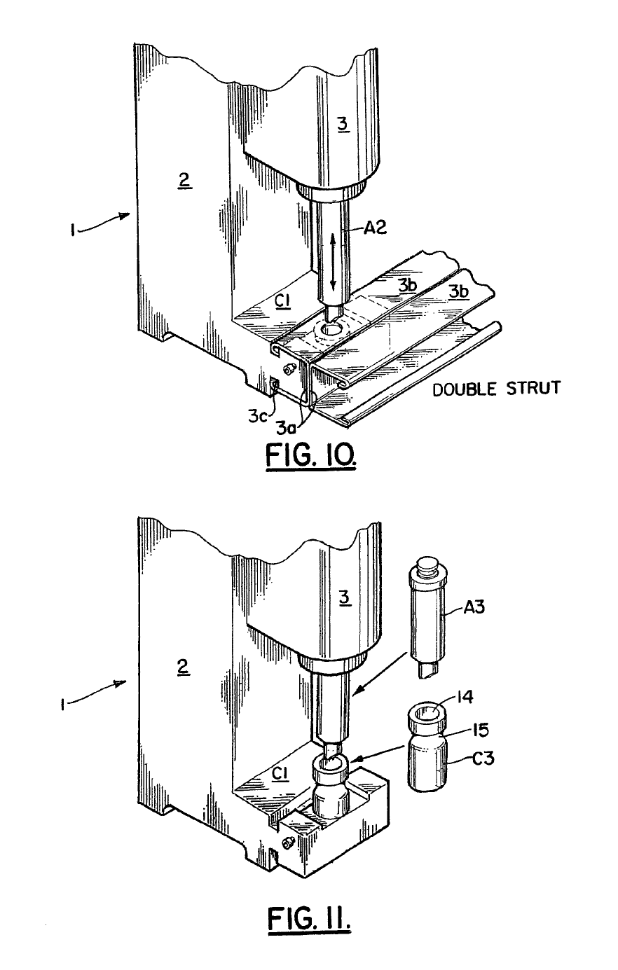

As depicted by FIGS. 4-12, an improved punch press 1 is disclosed. The improved punch press 1 of the present invention is configured to form or punch center and side holes in a work piece. In a preferred embodiment, the work piece will comprise a strut 3. Strut 3 in turn will comprise a base 3a and two side walls 3b extending from base 3a. Side walls 3b in turn will comprise inward curving lips 3c. As will be discussed further below, punch press 1 is capable of being utilized with a variety of struts 3.

The inventor contemplates that punch press 1 of the present invention may be manually controlled, numerically controlled through a computer (CNC), or hydraulically and/or electrically operated. A detailed construction of the components of punch press 1 will not be provided, as the general components of punch presses are well known in the art. However, a preferred embodiment of the basic and unique components of punch press 1 will be discussed.

In a preferred embodiment, and as depicted by FIGS. 4-12, punch press 1 of the present invention comprises a body region 2. In a preferred embodiment, body region 2 includes a ram 3. Ram 3 will be configured to move in a vertically linear manner. Ram 3 will further be configured to releasably attach a male punch A, thereto. Male punch A may be selected from a plurality of male punches having varying lengths. The length of the male punch A used will vary based on the particular strut 3 being utilized. As non-exhaustive examples of male punches having different lengths, male punches may be selected from the group consisting of A1, A2 or A3. See FIGS. 4, 8, and 11. Male punches A may also have different diameters, depending on the size of the hole desired. In short, male punch A can be any desired length sufficient to reach strut 3 when strut 3 is in position upon female die C, to thereby allow male punch A to enter strut 3 for hole punching. Preferred embodiments of female die C of the present invention will now be discussed.

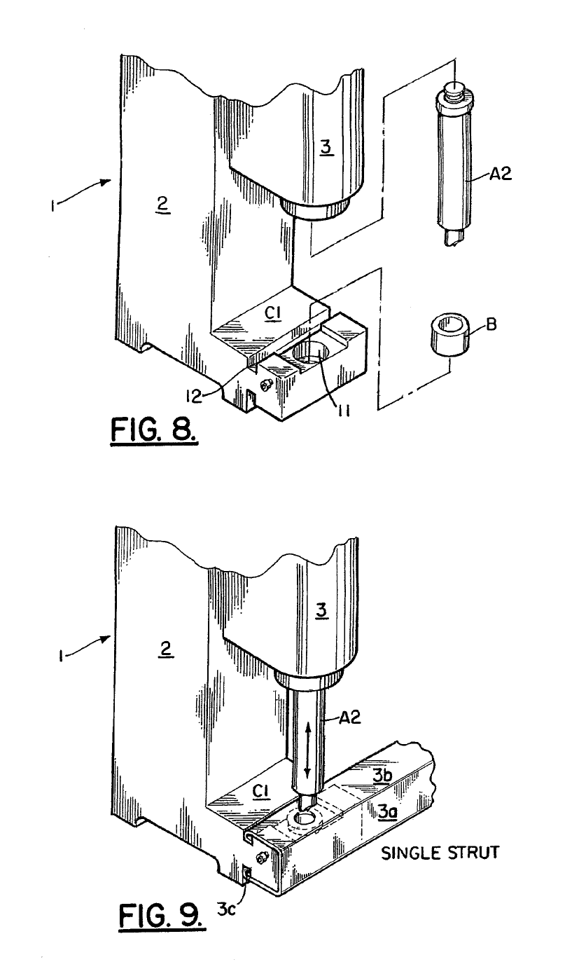

As depicted by FIGS. 4-12, punch press 1 will further comprise a female die C. In a preferred embodiment, female die C can be selected from a plurality of female dies—C1, C2, and C3. See FIGS. 4, 8, and 11. Body 2 of punch press 1 will further comprise a work bed 4. Work bed 4 in turn will comprise a first female die C1. First female die C1 in turn will be comprise an aperture 11 configured to receive a compatible male punch A. First female die C1 will further comprise a channel 12 configured to receive lips 3c of strut 3 to orient sidewall 3b of strut 3 toward male punch A, such that male punch A can enter sidewall 3b, thereby forming a side hole in sidewall 3b. In a preferred embodiment, aperture 11 of first female die C1 will further be configured to receive one of a plurality of collars B having varying internal diameters to match the external diameter of the male punch A. This will allow punch press 1 to punch holes of different diameters in strut 3. FIGS. 8, 9 and 10 depict the use of a preferred embodiment of punch press 1, in a single-strut and double-strut application, respectively, for side hole punching. As can be seen, in these applications, first female die C1 is being utilized with male punch A2 and collar B to form side holes in sidewalls 3b of single-strut 3 and double-strut 3, respectively.

In a further preferred embodiment of the invention, aperture 11 of first female die C1 will further be configured to receive a second female die—C2 or C3. C2 represents one preferred embodiment of the second female die. See FIG. 4. C3 represents another preferred embodiment of the second female die. See FIG. 11. A discussion of a preferred embodiment of second female die C2 will be provided first, followed by a discussion of second female die C3.

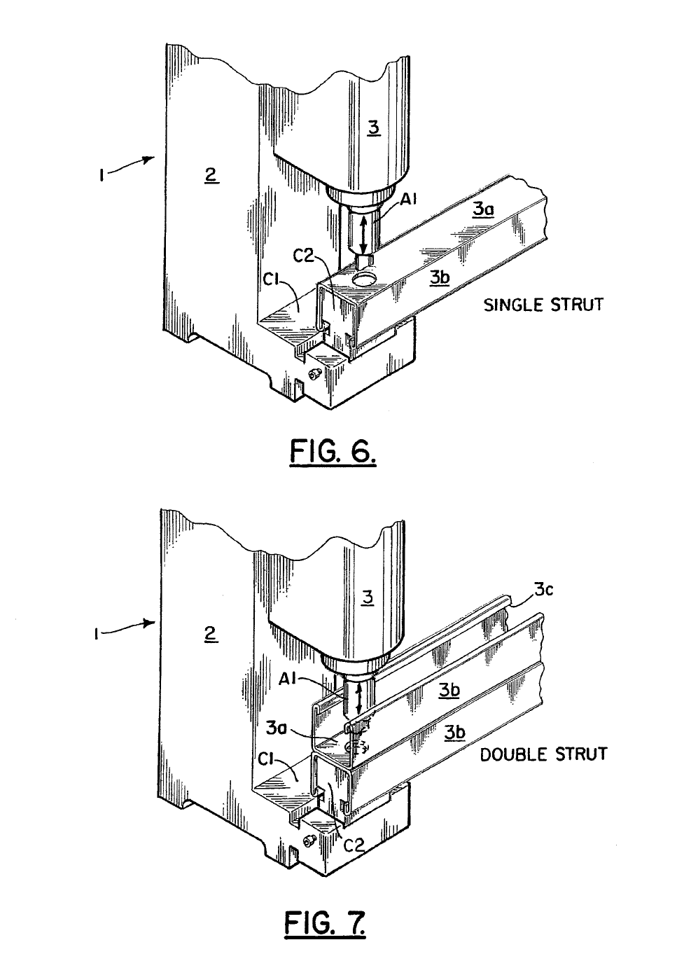

As depicted by FIG. 4, second female die C2 will be configured to fit in aperture 11 of first female die C1. As depicted by FIGS. 4 and 5, second female die C2 will further comprise an aperture 13 configured to receive a compatible male punch A. Second female die C2 will further comprise a side channel 14 configured to receive lips 3c of strut 3 to orient base 3a of strut 3 toward male punch A such that male punch A can enter base 3a, thereby foaming a center hole in base 3a. The term “center” is meant to refer to the a hole punched in base 3a, as opposed to a hole punched in sidewall 3b of strut 3. The center hole punched in base 3a may be anywhere along length of base 3a and does not necessarily have to be positioned at the dead center of base 3a. In a preferred embodiment, aperture 13 of second female die C2 will further be configured to receive one of a plurality of collars B having varying internal diameters to match the external diameter of the male punch A. As explained above, this will allow punch press 1 to punch holes of different diameters in strut 3. FIGS. 4, 5, 6, and 7 depicts the use of a preferred embodiment of the punch press 1, in a single-strut and double-strut application, respectively, for center hole punching. As can be seen, in these applications, second female die C2 is being utilized with male punch A1 and collar B to form center holes in bases 3a of single-strut 3 and double-strut 3, respectively. It should be noted that the combination of A1, B and C2 may also be utilized to create center holes in other types of struts, such as single-deep struts, and single-shallow struts.

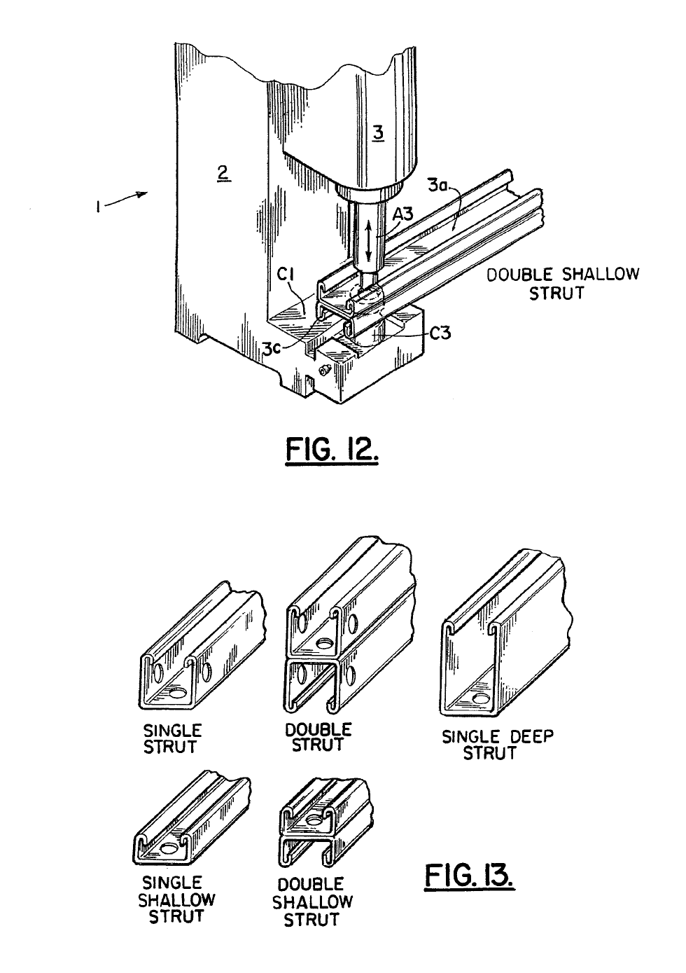

As depicted by FIG. 11, a discussion of a preferred embodiment of second female die C3 will now be provided. C3, like C2, will also comprise an aperture 14 configured to receive a compatible male punch A. Second female die C3 will further comprise a channel 15 configured to receive lips 3c of strut 3 to orient base 3a of strut 3 toward male punch A such that male punch A can enter base 3a, thereby forming a center hole in base 3a. In a preferred embodiment, aperture 14 of second female die C3 will further be configured to receive one of a plurality of collars B having varying internal diameters to match the external diameter of the male punch A to allow punch press 1 to punch holes of different diameters in strut 3. FIGS. 11 and 12 depict the use of a preferred embodiment of the punch press in a double-shallow-strut application, for center hole punching. As can be seen, in this application, second female die C3 is being utilized with male punch A3 to form a center hole in base 3a of double-shallow-strut 3.

In summary, improved punch press 1 of the present invention comprises a relatively simple construction and arrangement of elements. Yet, punch press 1 is efficient in operation and reduces the financial, labor, and time concerns associated with prior art punch presses. As can further be seen, improved punch press 1 of the present invention is versatile in that it is capable of forming both center and side holes in different types of struts. See FIG. 13.

While the invention has been described in terms of its preferred embodiment, other embodiments will be apparent to those of skill in the art from a review of the foregoing. Those embodiments as well as the preferred embodiments are intended to be encompassed by the scope and spirit of the following claims.

I claim:

1. A punch press to form side holes in a strut having a base, side walls extending from said base, said side walls comprising curved lips, said punch press comprising:
a. a work bed;
b. the work bed comprising a first female die;
c. the first female die configured to receive a compatible male punch;
d. the first female die further comprising a channel configured to receive the lips of the strut to orient a side wall of the strut toward the male punch for side hole punching.

2. The punch press according to claim 1, wherein the first female die is further configured to receive one of a plurality of collars having varying internal diameters to match the external diameter of the male punch.

3. The punch press according to claim 1, wherein the male punch is selected from a plurality of male punches having different lengths.

4. The punch press according to claim 3, wherein the male punch is of sufficient length to reach the strut, when the strut is on position on the first female die.

5. A punch press to form center and side holes in a strut having a base, side walls extending from said base, said side walls comprising curved lips, said punch press comprising:
a. a work bed;
b. the work bed comprising a first female die;
c. the first female die configured to receive a compatible male punch;
d. the first female die further comprising a channel configured to receive the lips of the strut to orient a side wall of the strut toward the male punch for side hole punching;
e. the first female die further configured to receive a second female die;
f. the second female die configured to receive a compatible male punch;
g. the second female die further comprising a channel to receive the lips of the strut to orient the base of the strut toward the male punch for center hole punching.

6. The punch press according to claim 5, wherein the first female die is further configured to receive one of a plurality of collars having varying internal diameters to match the external diameter of the male punch compatible with the first female die.

7. The punch press according to claim 5, wherein the second female die is further configured to receive one of a plurality of collars having varying internal diameters to match the external diameter of the male punch compatible with the second female die.

8. The punch press according to claim 5, wherein the male punch compatible with the first or second female die is selected from a plurality of male punches having different lengths.

9. The punch press according to claim 8, wherein the male punch is of sufficient length to reach the strut when the strut is on position on the first or second female die.
